(19) United States
(12) Patent Application Publication
(10) Pub. No.: US 2010/0079274 A1
(43) Pub. Date: Apr. 1, 2010

(54) System for Wireless Activation of Communication Indicators within an Industrial or Professional Working Environment

(76) Inventor: Robert H. WILSON, Austin, TX (US)

Correspondence Address: KAMMER BROWNING PLLC, 7700 BROADWAY, SUITE 202, SAN ANTONIO, TX, 78209, US

(21) Appl. No.: 12/568,593

(22) Filed: Sep. 28, 2009

Related U.S. Application Data
(60) Provisional application No. 61/100,757, filed on Sep. 28, 2008.

(51) Int. Cl. G08B 21/00; G08B 1/08

(52) U.S. Cl. 340/539.1; 340/540

(57) ABSTRACT

A system for the wireless activation or deactivation of one or more switches associated with one or more communication indicators within an industrial or professional working environment. The system includes at least one portable, handheld transmitter comprising at least one manually operated switch and a signal transmitter. Further included is at least one fixed indicator assembly comprising a signal receiver, at least one automatically operational switch, and at least one indicator capable of audibly or visually communicating a condition to workers within the industrial or professional working environment. The wireless indicator switch system is a highly flexible combination of a lightweight, small key fob type transmitter paired with a flexible receiver circuit board for controlling a variety of industrial and/or professional working environment indication devices. The wireless indicator switch will allow the indication device to be placed at its optimal location while allowing the worker to remain at their location and still activate the device. With the key fob sized transmitter, for example, the operator can easily activate an indicator light without leaving the work station.

### CROSS REFERENCE TO RELATED APPLICATIONS

This application claims the benefit under Title 35 United States Code §119(e) of U.S. Provisional Patent Application Ser. No. 61/100,757; filed Sep. 28, 2008; the full disclosure of which is incorporated herein by reference.

### BACKGROUND OF THE INVENTION

1. Field of the Invention

The present invention relates generally to indicators and status information communication systems within industrial and professional working environments. The present invention relates more specifically to a handheld wireless system for activating and deactivating audio/visual indicators and other switchable loads used in industrial facilities and professional working environments.

2. Description of the Related Art

Communication in an industrial or professional business setting is of vital importance to coordinating activities and maintaining operation and production. Employees in an industrial environment must communicate when they need parts, have a quality problem, require assistance, or need to stop the movement of an assembly line. Employees in professional working environments such as laboratories, schools, hospitals, etc. often need to alert others within the facility of similar needs, conditions, or requirements. Keeping an operation running is also of vital importance to productivity and service quality in a manner that depends upon systems for keeping employees at their workstations. However, due to equipment, walls, and other physical divisions that block sight lines, noise that makes conversation difficult, and other distractions, it is often difficult for employees to communicate with each other while they are restricted at their workstations.

Communication in industrial and professional work settings is addressed in several ways. No communication is required if an employee is able to simply leave their workstation to fix a problem. However, employees are not, in many circumstances, able to continue to perform their work while they are away from their workstations. In many situations employees are not able to leave their work in a safe condition to seek help or acquire materials. In addition, some problems can only be addressed by a person that is physically removed from the workstation that is in need of assistance. If the employee leaves their workstation to find the appropriate party to address a problem and then returns to their workstation, downtime may be caused that can impact productivity depending on the employee and the responsible party's location. Instead of leaving their workstation, an employee may yell or use hand signals to attract the attention of the responsible party. This method distracts the employee's attention away from their work and only works as long as the environment is not too loud or if visual contact is possible.

Efforts have been made in the past to develop systems for communication in industrial and professional services facilities. Some of these systems are commonly referred to as “andon” systems. An andon system typically has a cord or light chain that runs through an employee's workstation and is tied to a switch. When the switch is activated, a light on a “scoreboard” illuminates to indicate the station that activated the system. When activated, a tone generator may begin to sound to attract attention. In addition, andon systems may be tied into a conveyor system or a production control system to stop the production line. These systems are effective because they allow employees to quickly activate the system without leaving their workstation and then continue to work while waiting for assistance. However, andon systems are typically “hardwired” which makes them expensive to install and limited in range. Andon systems tend to be inflexible so that changes in layout of a line necessitate revamping the andon system. Andon systems are also expensive to build and maintain due to the need to integrate them with other systems. Andon systems are generally too expensive and impractical for manufacturers who frequently change production line layouts. As a result, most industrial environments do not use andon systems but rely on simpler, less efficient methods as discussed above.

Similar problems arise in a professional services environment. While individual employees may be responsible for a particular lab or instrument room they are seldom fixed in position within that room such that they might always be adjacent a call button or other andon type switch. In professional services environments, employees must be free to move about within their labs or test facilities, and yet must still be able to call for assistance when necessary.

Some efforts have been made to provide more versatile devices to serve as communication indicators in industrial and professional service working environments. One such effort is reflected in the systems and methods disclosed in co-owned U.S. Pat. No. 7,006,792; issued Feb. 28, 2006; entitled Wireless Andon Communication Method and System; the entire disclosure of which is incorporated herein by reference. While the systems and methods of the cited reference solve many of the problems associated with portability and versatility in industrial working environments there remain many situations where an even more “portable” method for activating such work space communication indicators would be desirable.

In view of the foregoing, a system is needed for providing communication in industrial and professional work environments quickly and effectively while keeping employees on task and in safe conditions. Such a system must be portable and compact, cost effective, easy to install, adaptable to changes in layout, and applicable to a wide range of industrial and professional working environments. The present invention provides a unique and beneficial way to activate an industrial or professional work space communication indicator, whether it is a light, sound, vibration, strobe, or other type of indicator or signaling device or combination thereof. The system of the present invention allows for even greater portability and convenience to the employee, allowing them greater mobility, and therefore greater safety, in their working environment. The system remains relatively simple to construct, install, and maintain, with fewer fixed and hardwired components than similar systems that attempt to carry out the same function.

### SUMMARY OF THE INVENTION

In fulfillment of the above stated objectives and directed to solving the above stated problems, the present invention provides a system for the wireless activation or deactivation of a switch associated with a communication indicator within an industrial or professional working environment. The system includes a portable, handheld transmitter comprising at least one manually operated switch and a signal transmitter. Further included is a fixed indicator assembly comprising a signal receiver, at least one automatically operational switch, and at least one indicator capable of audibly or visually communicating a condition to workers within the industrial or professional working environment. The wireless indicator switch system is a highly flexible combination of a lightweight, small, key fob type transmitter paired with a flexible receiver circuit board for controlling a variety of industrial and/or professional working environment indication devices.

The present invention is therefore comprised of two primary components, a transmitter and a receiver, and optionally a third component, a local area data network. The transmitter as described above is a very small device similar to an automotive key fob used to lock and unlock one's vehicle. The transmitter would be lightweight and have a very small form factor to allow it to easily be carried around by the individual workers. The transmitter would be battery powered and can be set to different channels using a dip switch or trace cut selection system. The transmitter would be flexible and allow for different configurations and types of buttons depending on the user's needs. The transmitter could have one to eight (or more) buttons that could be of various types of rubber, plastic, or other tactile surface type buttons or switches.

The receiver of the present invention is comprised of a small circuit board that would receive the signals from the transmitter and then turn on and off the various communications indicators and items attached to it. The receiver would allow for various combinations of inputs to allow it to control a variety of output configurations or capabilities simply by attaching the device wires to the circuit board in another configuration. The receiver would also incorporate a dip switch (or other resettable selection device) to allow for secure communication (a confirmation signal “handshake”) between it and the specified transmitter with the same dip switch setting.

The receiver of the present invention would preferably include a communications processor and a wireless data communications transceiver that would allow it to convey activation and deactivation data to a central processing system through a local (or wide) area data processing network. Such interconnection will allow for not only the local communication of the employee's requirements but also a record keeping function and the communication of the need to remote systems and personnel.

### BRIEF DESCRIPTION OF THE DRAWINGS

FIG. 1 is a schematic block diagram showing each of the major elements of the system of the present invention and their internal functional components.

FIGS. 2A and 2B are plan views of two examples of the hand carried transmitter component of the system of the present invention.

FIG. 3 is a perspective view of one basic embodiment of the system of the present invention showing a hand carried transmitter component and a fixed receiver component associated with an industrial indicator.

FIG. 4 is a partially schematic diagram showing the multi-indicator hand carried transmitter of FIG. 2B utilized in conjunction with multiple industrial indicators as might typically be found within an industrial environment implementing the system of the present invention.

FIG. 5 is a perspective view of an alternate embodiment of the system of the present invention showing the use of multiple hand carried transmitter components and a single fixed receiver component associated with multiple indicator devices.

### DETAILED DESCRIPTION OF THE PREFERRED EMBODIMENTS

Reference is now made to the accompanying Drawing figures for a more detailed description of the preferred embodiments of the present invention. In these Drawing figures the following elements and components are consistently identified across the Drawing figures with the reference numerals that correspond as follows:

### 1. COMPONENT LISTING

10 industrial indicator control system
12 hand carried transmitter component
14 fixed receiver component
16 wireless local area data network component
18 manual pushbutton switches
20 transmitter control circuitry
22 transmitter power supply (batteries)
24 signal transmitter
26 receiver pairing switches (DIP)
28 transmitter status indicators
30 control signal from transmitter
32 signal receiver
34 receiver control processor
36 solid state load switches
38 power transformer
40 external power supply
42 industrial indicators (switched loads)
44 transmitter pairing switches (DIP)
46 receiver communications processor
48 wireless data communications transmitter/receiver
50 wireless data communications signal
52 wireless data communications transmitter/receiver
54 industrial facility data processing system
60 single switch hand carried transmitter
62 transmitter case
64 key ring
66 off button switch
68 on button switch
70 transmitter status indicator
72 multi-switch hand carried transmitter
74 transmitter case
76 transmitter antenna
78 component off button switch
80 component on button switch
82 component status indicator
84 industrial indicator strobe light
86 indicator cabinet mount
88 indicator power supply conduit
90 strobe support and motor
92 strobe light
94 wireless switch receiver
96 industrial indicator illuminated sign
98 wireless switch receiver
100 overall industrial environment
102 indicator sign panel
104 industrial machinery power interrupt
106 wireless switch receiver
108 electrical plug connectors
110 industrial indicator audible alarm
112 wireless switch receiver
114 loudspeaker/siren
116 indicator lights
120 multi-indicator system
122a-122c multi switch hand carried transmitters
124 multi-indicator cabinet mount
126 multi-indicator power supply conduit
128 wireless switch receiver
130 wireless receiver antenna
132a-132c multiple indicator devices

### 2. DETAILED DESCRIPTION OF THE DRAWING FIGURES

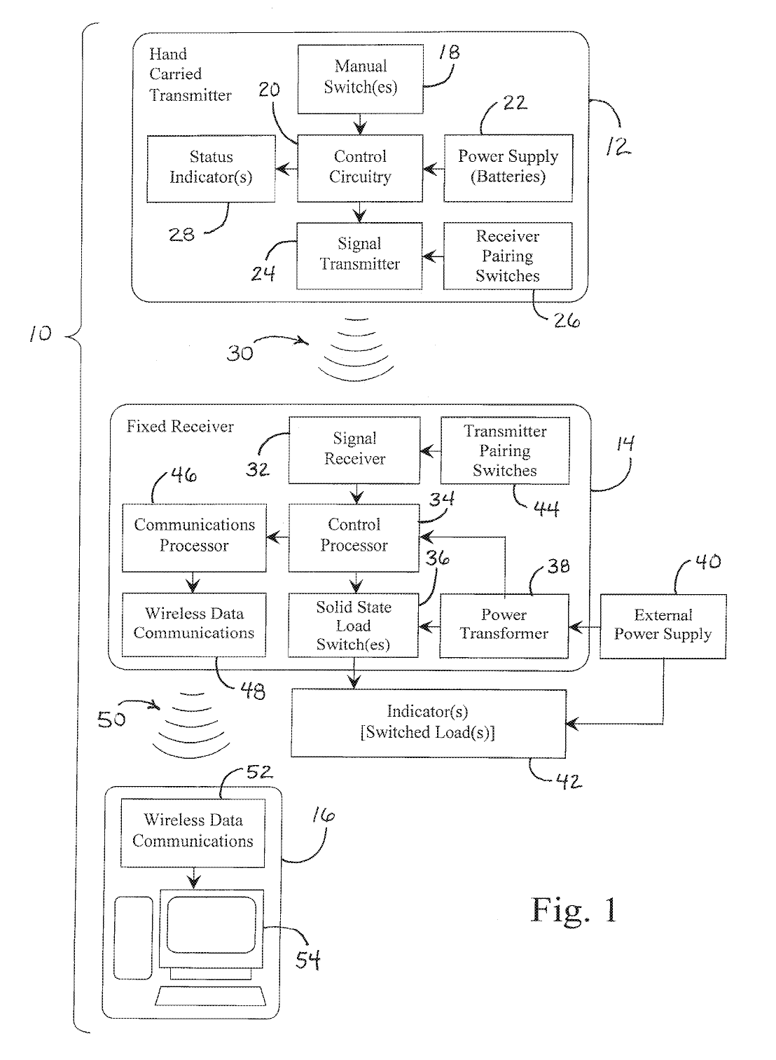

Reference is made first to FIG. 1 for a detailed description of the functional components associated with the overall system of the present invention and the manner in which these components interact to achieve the objectives of the system. While the examples given in the following detailed description might specifically refer to either an industrial environment or to a professional services work environment, those skilled in the art will recognize that the systems described might function to achieve the objectives of the invention in most any working environment where visual or audible communication is required. As such the use of “industrial” and “professional” should be considered to be interchangeable in the present descriptions.

Wireless industrial indicator control system 10 as shown in FIG. 1 generally comprises three primary functional components. Hand carried transmitter 12 provides the basic mechanism whereby the user is able to initiate the activation or control of an indicator. Fixed receiver 14 is the basic receiving unit for receiving a signal from a hand carried transmitter and performing the activation of the indicator. Data processing network 16 provides wireless data communications with the balance of the components of the system of the present invention and integrates this communication into an existing industrial environment data processing and control system.

Hand carried transmitter 12 as shown in FIG. 1 is a schematic example of a typical hand carried transmitter, further examples of which are described in more detail below. The basic components for each of the various types of hand carried transmitters 12 utilized in the system of the present invention are essentially the same. The device shown schematically in FIG. 1 represents a hand carried transmitter 12 that might serve to control a single industrial indicator or through multiple duplicate circuit components serve to control more than one industrial indicator. The manner in which a single hand carried transmitter might control multiple indicators is described in more detail below.

Transmitter 12 is comprised primarily of manual switches 18 which in the preferred embodiment of the present invention may number anywhere from 2 to 8. These switches are typically associated in pairs in order to provide both an on switch and an off switch for the specific industrial indicator. Those skilled in the art will recognize that in place of button switch pairs, a single switch may be provided that can be placed in an on or off condition. Manual switches 18 are connected directly to control circuitry 20 which in the preferred embodiment may be a microcontroller or microprocessor integrated into the hand carried transmitter 12. Control circuitry 20 conveys the condition of the manual switches 18 to both signal transmitter 24 and optional status indicators 28. Signal transmitter 24 generates the necessary radio frequency or other electromagnetic wave signal 30 that is transmitted over a distance to one or more fixed receivers 14. Status indicators 28 are optionally provided on hand carried transmitter 12 as a manner of allowing the user to determine the status of the switch without actually viewing the switched indicator at the remote location.

Transmitter 12 in the preferred embodiment is powered by power supply 22 generally comprised of a small lithium battery or the like. In addition to the above described circuitry, transmitter 12 integrates receiver pairing component 26 that allows the transmitter to be matched with or paired with a fixed receiver 14. In the preferred embodiment, this receiver pairing component may comprise an array of four DIP switches that can be set to match a similar set of DIP switches on the fixed receiver 14. Other mechanisms (solid state or mechanical switches) for coding and pairing a transmitter 12 with one or more fixed receivers 14 are anticipated.

Fixed receiver 14 as shown in FIG. 1 provides a typical example of the circuitry required for receiving a signal from transmitter 12 and activating or de-activating an indicator. One or more of fixed receivers 14 would be positioned in association with a variety of different industrial and/or professional services communication indicators as described in more detail below. Receiver 14 in the preferred embodiment includes signal receiver 32 which is tuned and configured to receive the activation signal 30 from the signal transmitter 24 positioned in hand carried transmitter 12. As mentioned above, fixed receiver 14 incorporates transmitter pairing switches 44 which in the preferred embodiment are DIP switches that may be set to match and pair with the similar set of switches in hand carried transmitter 12 as described above.

Signal receiver 32 receives and conveys the activation signal 30 to control processor 34 within fixed receiver 14. Control processor 34 may in the preferred embodiment be either a microcontroller or a microprocessor. Because the present invention anticipates the optional communication of additional data to a local area network, it may be preferable for control processor 34 to be a basic microprocessor that can be programmed and re-programmed according to the specific needs of the particular work environment within which the system operates.

Control processor 34 directs the operation of solid state load switches 36 which may receive power from power transformer 38 which in turn receives power from an external power supply 40. Power transformer 38 also provides the necessary electrical power for the operation of the balance of the electronic components within fixed receiver 14. Solid state load switches 36 may be any of a number of different types of solid state power switching devices such as MOSFET type electronic devices capable of switching the voltages and currents typically associated with industrial indicators.

Fixed receiver 14 will generally be configured on a circuit board and connected with and attached to the industrial indicator (switched load) 42 that it is intended to control. Indicator 42 may receive a separate source of power directly from external power supply 40 or may receive its switched power through solid state load switches 36. Those skilled in the art will recognize that the switching mechanism may occur through one or more (multiple) solid state switches and/or physically switching solenoids that may be positioned within the fixed receiver component 14 or positioned within the indicator switched load component 42. Various industrial indicators and switching devices configured in this manner are described in more detail below.

As indicated above, the system of the present invention, in addition to activating or de-activating an industrial indicator or switching a load, serves to communicate the status of these industrial and professional work environment systems to a data processing network associated with the environment. The system accomplishes this by directing appropriate data transfer from control processor 34 through communications processor 46 within fixed receiver 14. Communications processor 46 may in the preferred embodiment be a separate microprocessor whose function it is to receive, accumulate, and transmit informational data through wireless data communications component 48 by way of a wireless data signal 50 through to the local area network associated with the operation of the industrial environment. Communications processor 46 may also be integrated into control processor 34 and carry out the necessary functions associated with each controller.

The local area network data processing system 16 associated with the industrial or professional work environment will have a wireless data communications component 52 designed to receive and transmit data signals back and forth with the wireless data communications component 48 of the various fixed receivers 14 throughout the system. In this manner, data regarding the status of the system as a whole is communicated to the central data processing system 54 associated with the industrial environment, warehouse, assembly line, laboratory, etc. Computer system 54 may in the preferred embodiment also be a monitoring and control system that allows centralized control over all of the indicators within the system.

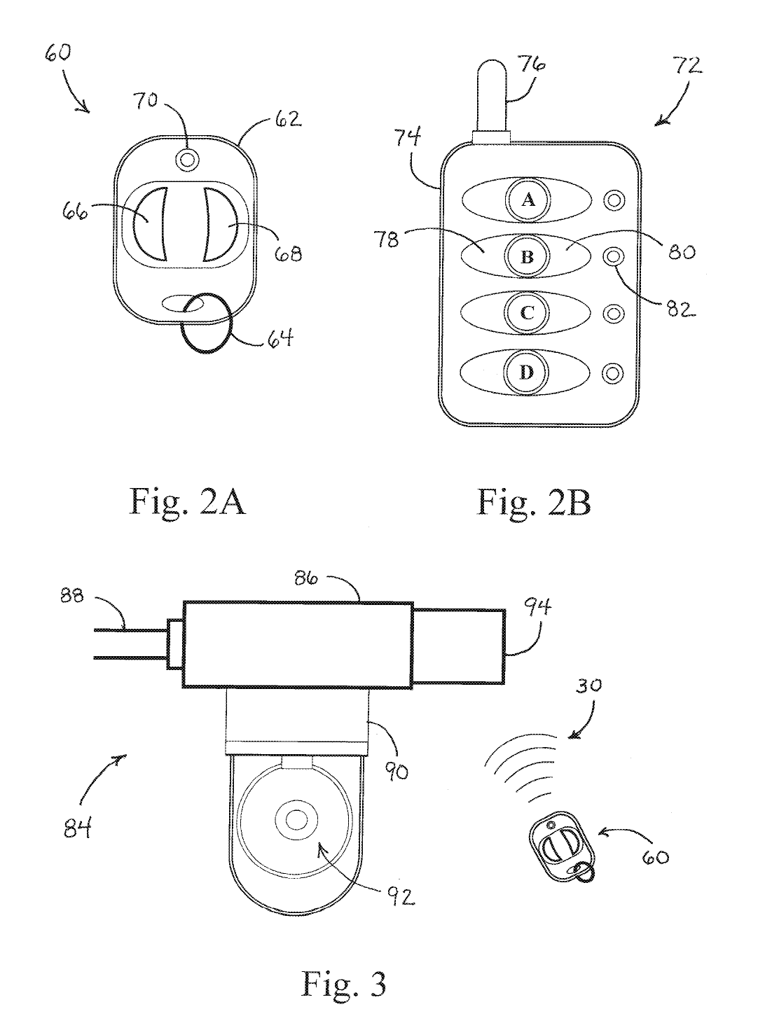

Reference is now made to FIGS. 2A & 2B which are plan views of two examples of the hand carried transmitter component of the system of the present invention. FIG. 2A shows a handheld transmitter integrating a single activation/deactivation switch pair while FIG. 2B shows a larger (but still handheld) transmitter that includes four sets of activation/deactivation switch pairs. Single switch pair handheld transmitter 60 as shown in FIG. 2A, comprises transmitter case 62, key ring 64, off button switch 66, and on button switch 68. Case 62 is sized similar to an automotive key fob with similar types of push buttons. Two push buttons, off button 66 and on button 68, are shown although it is known in the art that a single button may be configured to alternately switch on or switch off some function intended to be activated or deactivated. Other switch arrangements can be implemented, but in general the embodiment shown in FIG. 2A is directed to a simple activation or deactivation of a single, specific communication indicator of the types described below. Transmitter 60 may optionally include status indicator 70 which allows the user to view the state of the switched indicator without actually viewing or hearing the indicator (which is positioned specifically for others to take notice of).

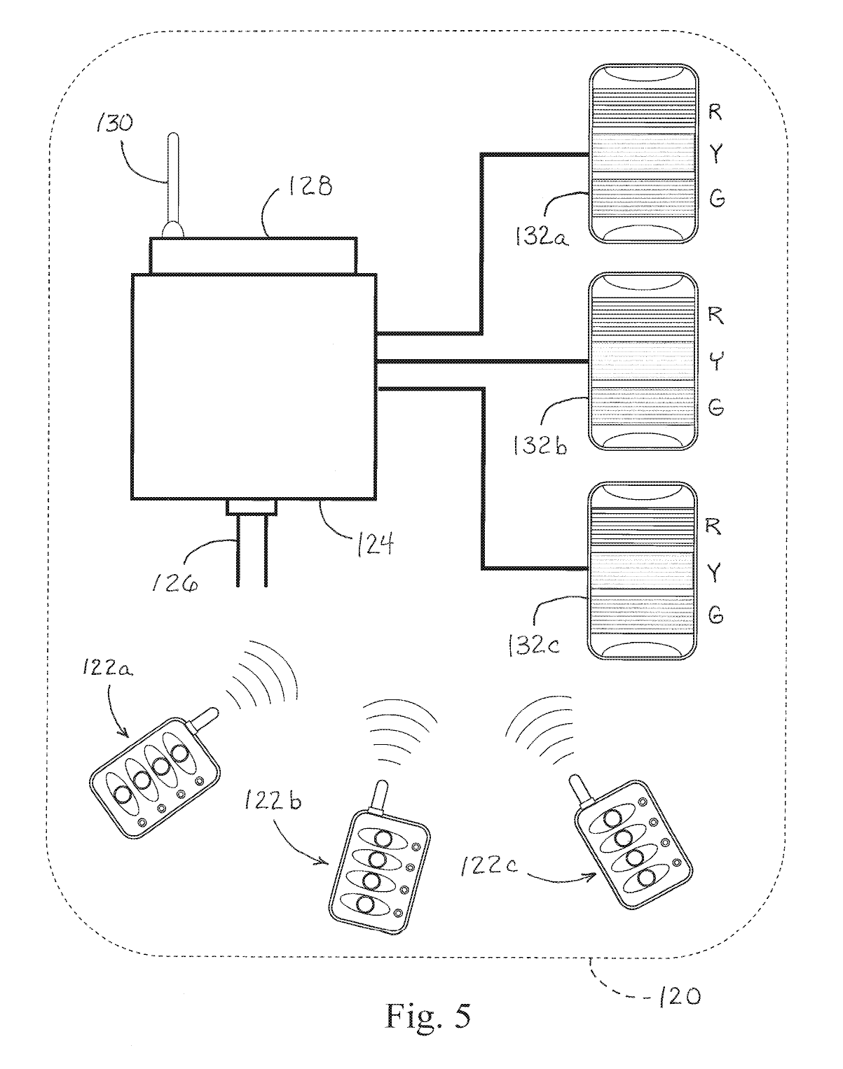

It is also possible to structure the functionality of the single switch system shown in FIG. 2A such that sequential activations of the single switch progressively alter the actions or characteristics of the associated indicator assembly. The indicator assembly may, for example comprise a light stack with a column or row of three lights, as an example, red, yellow, and green (such as those shown in FIG. 5). The single transmitter may readily serve to allow a progression through the lights in the light stack such that a single press of the on button changes the stack light from green to yellow (suggesting that assistance may be needed but is not urgent) and a second press of the same on button changes the yellow indicator light to red (suggesting that the assistance required is more urgent).

The embodiment of the handheld transmitter 72, shown in FIG. 2B, is directed to a multi-indicator assembly or to multiple indicator assemblies. The embodiment shown may be considered to operate like four separate single indicator transmitters. Each (on/off) switch pair 78/80 may, once again, be replaced by a single button switch that serves to sequentially turn on or off the switch with which it is associated. The entire array of switches (four in the example shown) could also be directed to an association with either four discrete communication indicator assemblies or could be associated with a single assembly with multiple states. With the light stack example given above, the multi-switch embodiment could control an indicator to illuminate the green light (or not) with switch pair “A”; the yellow light (on/off) with switch pair “B”; the red light (on/off) with switch pair “C”; and finally, perhaps, an audible alarm with switch pair “D”. Any combination of multi-indicator assemblies or single indicator assemblies can be controlled through the appropriate pairing and “programming” of the transmitters and receivers.

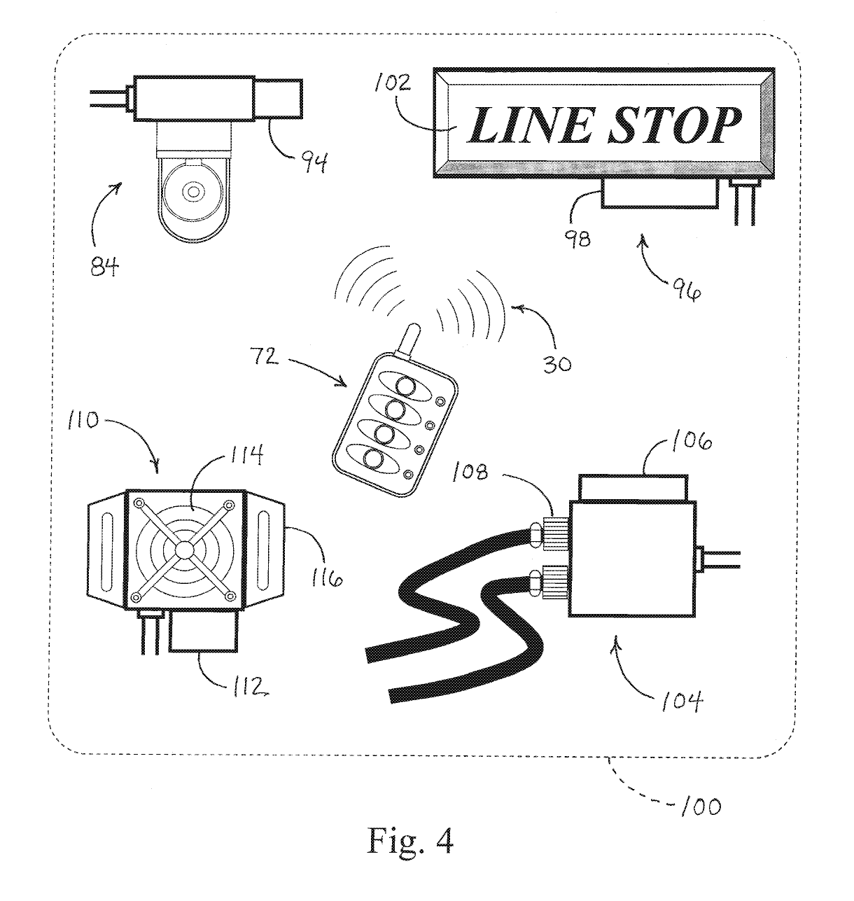

The multi switch handheld transmitter 72 shown in FIG. 2B includes a transmitter case 74 and a transmitter antenna 76. The added antenna 76 may be necessary in order to provide a sufficient multi-frequency signal transmission that is not necessary with the embodiment shown in FIG. 2A. In a manner similar to the transmitter of FIG. 2A, an optional status indicator 82 may optionally be provided for each of the on/off (80/78) switch pairs that are present on the multi-indicator device. The manner in which this embodiment of the handheld transmitter operates is described in more detail below with regard to FIG. 4.

FIG. 3 is a perspective view of one basic implementation embodiment of the system of the present invention showing a hand carried transmitter component and a fixed receiver component associated with an industrial or professional work environment indicator. FIG. 3 provides an example of the simplest connection between the handheld transmitter 60 and a typical fixed indicator assembly 84 of the present invention. In this example, a single switch handheld transmitter 60 is configured to control the operation of a simple flashing strobe light 92 associated with the indicator assembly 84. Strobe light 92 may be an AC powered rotating lamp extending from strobe support and motor 90. These components are mounted to indicator cabinet mount 86 which in turn may preferably be mounted to the wall or ceiling of the work area. Integrated into cabinet mount 86, or attached to its side, is wireless switch receiver 94 which, as described above, includes the necessary receiver and control circuitry to receive a signal from the handheld transmitter 60 and translate it into the activation or deactivation of a switch (preferably solid state) to turn the indicator (light in this case) on or off. Because this indicator assembly is typically fixed, power to the unit may be supplied by hardwired electrical lines through the power supply conduit 88 as shown.

FIG. 4 is a partially schematic diagram showing the multi-indicator hand carried transmitter of FIG. 2B utilized in conjunction with multiple industrial indicators as might typically be found within an industrial environment implementing the system of the present invention. This multi-indicator device functions generally as described above, and can serve to activate/deactivate as many as four different indicator assembly devices. Shown as examples in FIG. 4 are the industrial indicator strobe light 84, as described with FIG. 3 with wireless switch receiver 94 associated therewith. In a similar manner, multi-switch handheld transmitter 72 may control: industrial indicator illuminated sign 96 (having wireless switch receiver 98 and indicator sign panel 102); industrial machinery power interrupt 104 (having wireless switch receiver 106 and electrical plug connectors 108); and (as a further example) industrial indicator audible alarm 110 (having wireless switch receiver 112 and loudspeaker/siren 114 with optional indicator lights 116). Collectively these components may, as an example, make up the entire industrial/professional working environment system 100 shown as a typical example in FIG. 4 of the functional implementation of the multi-channel operation of the system.

### 3. ALTERNATE PREFERRED EMBODIMENTS

Reference is finally made to FIG. 5 for a description of an alternate embodiment of the present invention that includes multiple transmitters and a single indicator assembly that includes multiple indicators. In this embodiment, a number of different users (workers in different locations) may each carry one of a number of multi switch (or single switch) handheld transmitters 122a-122c that are paired to a fixed receiver 124 and more specifically to one of a number of discrete indicators 132a-132b controlled by that fixed receiver 124. By appropriate pairing of the signal transmissions and receptions a single receiver 124 may distinguish the signals it receives and activate or deactivate one of a number of discrete indicators 132a-132c at a particular location. In the example shown, each indicator is a stack light of the type discussed above wherein (for example) the repetitive press of the single switch on the transmitter progressively moves the indicator light from green to yellow to red depending on the urgency of the need. Alternately, the multi switch transmitters 122a-122c as shown in FIG. 5 may discretely activate the various functions (lights) within each stack light device. Each of the different stack light sets 132a-132c would (for example) be associated with a different physical location within the facility and the appropriate personnel could respond according to the location of the need and the urgency of the request for assistance.

The receiver unit shown in FIG. 5 may preferably include multi-indicator cabinet mount 124 which is supplied with the requisite power through power supply conduit 126. Wireless switch receiver 128 includes wireless receiver antenna 130 to facilitate resolution of the incoming signals from the multiple transmitters in this embodiment of the system. As with the systems described above, this alternate embodiment may include data communications links to a local area network (LAN) or optionally into a wide area network (WAN) such as the Internet, for remote data logging or monitoring. Such connection to a data network may be accomplished through the use of components integrated into the cabinet 124 as shown in FIG. 5, or may comprise connection to a separately mounted wireless (or wired) network transceiver.

The multiple indicator devices 132a-132c shown in FIG. 5 are of the stack light type of indicators that may serve to best display the type of assistance that is required by a particular employee at a particular location. Using the standard green/yellow/red (G/Y/R) color combination, these indicators may easily provide information about the urgency of the request for assistance. These color coded lights (in G/Y/R or some other color combination) may alternately serve to indicate different needs such as “parts needed” or “relief needed” or “job completed” or the like.

Although the present invention has been described in terms of the foregoing preferred embodiments, this description has been provided by way of explanation only, and is not intended to be construed as a limitation of the invention. Those skilled in the art will recognize modifications of the present invention that might accommodate specific industrial or professional working environments and requirements. Those skilled in the art will further recognize additional means for implementing suitable communication indicator assemblies to accommodate various commonly encountered conditions and requirements in various industrial and professional settings. Such modifications, as to system structure, configuration, size and communication methodologies, where such modifications are coincidental to the type of industrial or professional environment present, do not necessarily depart from the spirit and scope of the invention.

I claim:

1. A system for the wireless activation or deactivation of a switch associated with a communication indicator within an industrial or professional working environment, the system comprising:
(a) a portable, handheld transmitter comprising at least one manually operated switch and a signal transmitter; and
(b) a fixed indicator assembly comprising a signal receiver, at least one switch, and at least one indicator, the at least one indicator capable of audibly or visually communicating a condition to workers within the industrial or professional working environment.

2. The system of claim 1 wherein the signal transmitter and signal receiver operate using radio frequency (RF) signals.

3. The system of claim 1 wherein the signal transmitter and signal receiver operate using infrared (IR) light signals.

4. The system of claim 1 wherein a signal transmitted from the signal transmitter to the signal receiver comprises a handshake signal to verify a proper association between the handheld transmitter and the indicator assembly.

5. The system of claim 4 wherein the handheld transmitter and the indicator assembly each further comprise a handshake signal encoder for matching and identifying the transmitter to the receiver.

6. The system of claim 5 wherein the handshake signal encoders each comprise a set of DIP switches that may be set and reset to match the transmitter to the receiver.

7. The system of claim 1 wherein the indicator comprises a single light source.

8. The system of claim 1 wherein the indicator comprises an audible sound generator.

9. The system of claim 1 wherein the indicator comprises a multiple light source.

10. The system of claim 9 wherein the multiple light source comprises a stack light having three distinct light sources arranged in a column, each of the light sources having a color distinct from the others.

11. The system of claim 1 wherein the at least one manually operated switch of the handheld transmitter comprises an activation switch and a deactivation switch pair.

12. The system of claim 1 wherein the at least one manually operated switch of the handheld transmitter comprises four paired activation switches and deactivation switches.

13. The system of claim 1 wherein the industrial or professional working environment further comprises a local area data network and the fixed indicator assembly comprises a data communications processor for providing information on the activated/deactivated condition of the system to the network.

14. The system of claim 13 wherein the local area network comprises a wireless network and the data communications processor comprises a wireless data communications transceiver.

15. A system for the wireless activation or deactivation of a plurality of switches associated with a plurality of communication indicators within an industrial or professional working environment, the system comprising:
(a) a plurality of portable, handheld transmitters each comprising at least one manually operated switch and a signal transmitter; and
(b) a fixed multi-indicator assembly comprising at least one signal receiver, a plurality of switches, and a plurality of indicators, the plurality of indicators each capable of audibly or visually communicating a condition to workers within the industrial or professional working environment with each indicator associated with a separate one of the plurality of handheld transmitters.

16. The system of claim 15 wherein each of the plurality of indicators comprises a stack light having two or more discrete light elements and the activation of a light element provides an indication of the urgency of the communication.

17. The system of claim 15 wherein the handheld transmitters are each associated with a discrete physical location within the industrial or professional working environment.

18. The system of claim 15 wherein the handheld transmitters are each associated with a separate individual worker within the industrial or professional working environment.

19. A system for the wireless activation or deactivation of a switch associated with a communication indicator within an industrial or professional working environment, the industrial or professional working environment including a local area data communications network, the system comprising:
(a) a portable, handheld transmitter comprising at least one manually operated switch and a signal transmitter;
(b) a fixed indicator assembly comprising a signal receiver, at least one switch, and at least one indicator, the at least one indicator capable of audibly or visually communicating a condition to workers within the industrial or professional working environment; and
(c) a data communications processor for providing information on the activated/deactivated condition of the system to the local area data communications network.
